(19) United States
(12) Patent Application Publication
(10) Pub. No.: US 2023/0148570 A1
(43) Pub. Date: May 18, 2023

(54) Birdhouse

(71) Applicant: Technaxx Deutschland GmbH & Co. KG, Schöneck (DE)

(72) Inventor: Pascal Pekcan, Frankfurt (DE)

(73) Assignee: Technaxx Deutschland GmbH & Co. KG, Schöneck (DE)

(21) Appl. No.: 17/590,896

(22) Filed: Feb. 2, 2022

(30) Foreign Application Priority Data
Nov. 16, 2021 (DE) 20 2021 106 477.3

(51) Int. Cl. A01K 31/14; A01K 29/00; A01K 39/01

(52) U.S. Cl. CPC A01K 31/14; A01K 29/005; A01K 39/01

(57) ABSTRACT

A birdhouse (2) includes an outer housing (4), a birdseed container (16) insertable into the outer housing (4) for mounting therein, and a camera unit (36) insertable into the birdfeed container (16). It further includes a digital camera (66) and a motion sensor (70), the camera unit (36) comprising a control unit (72) that triggers the digital camera (66) when the motion sensor (70) detects the approach or presence of a bird.

### CROSS-REFERENCE TO RELATED APPLICATION

This application claims the benefit of German Patent Application No. 20 2021 106 477.3, filed Nov. 16, 2021, which is incorporated herein in its entirety by reference.

### TECHNICAL FIELD

The present disclosure relates to birdhouses or birdfeeders.

### BACKGROUND

Birdhouses, also called birdfeeders, are roofed feeding places for free-living birds, which are stocked with bird food or birdseed. They come in a variety of designs.

Often, a site suitable for feeding and attracting birds is not the same as an optimal site for observation. Also, bird watching at night-time is difficult.

### SUMMARY

The objective of the disclosure is to provide a remedy in this respect and to specify a birdhouse which can be manufactured simply and inexpensively, and which allows for convenient observation and documentation of fed birds at any time of the day or night.

This objective is met by a birdhouse a claimed.

Accordingly, a birdhouse is provided having an outer housing, a birdseed container insertable into the outer housing for mounting therein, and a camera unit insertable into the birdseed container, the camera unit comprising a digital camera and a motion sensor, wherein the camera unit comprises a control unit that triggers the digital camera when the motion sensor senses or detects the approach or presence of a bird.

The birdhouse therefore enables photographic or cinematic documentation of birds at feeding places with simple means. Due to the modular design, production, assembly, and operation are kept particularly simple.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows a birdhouse in front view,

FIG. 2 shows the birdhouse in rear view,

FIG. 3 shows a birdseed container of the bird house in front view,

FIG. 4 shows the birdseed container in rear view,

FIG. 5 shows a front view of a camera unit for insertion into the bird house,

FIG. 6 shows an internal view of the camera unit with open cover,

FIG. 7 shows a sequence of operations in assembling the birdhouse,

FIG. 8 shows a sequence of operations during insertion of the camera unit into the birdhouse,

FIG. 9 is an exploded view of a mounting bracket for the birdhouse,

FIG. 10 is a detailed illustration of the assembled bracket for a floor or wall mounting, and

FIG. 11 shows a top view of an alternative bracket for a railing assembly.

### DETAILED DESCRIPTION

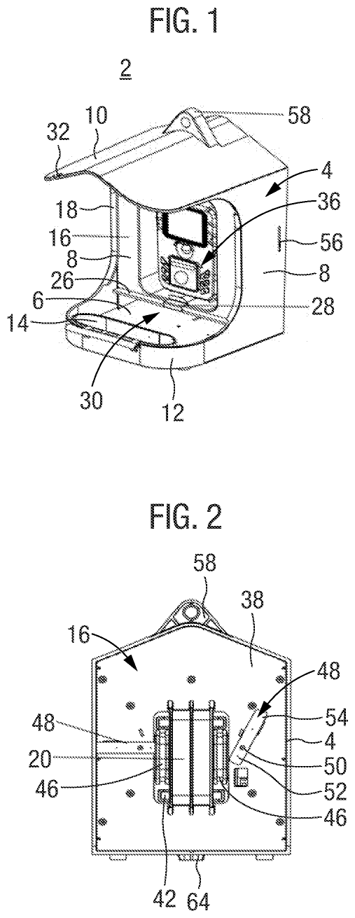

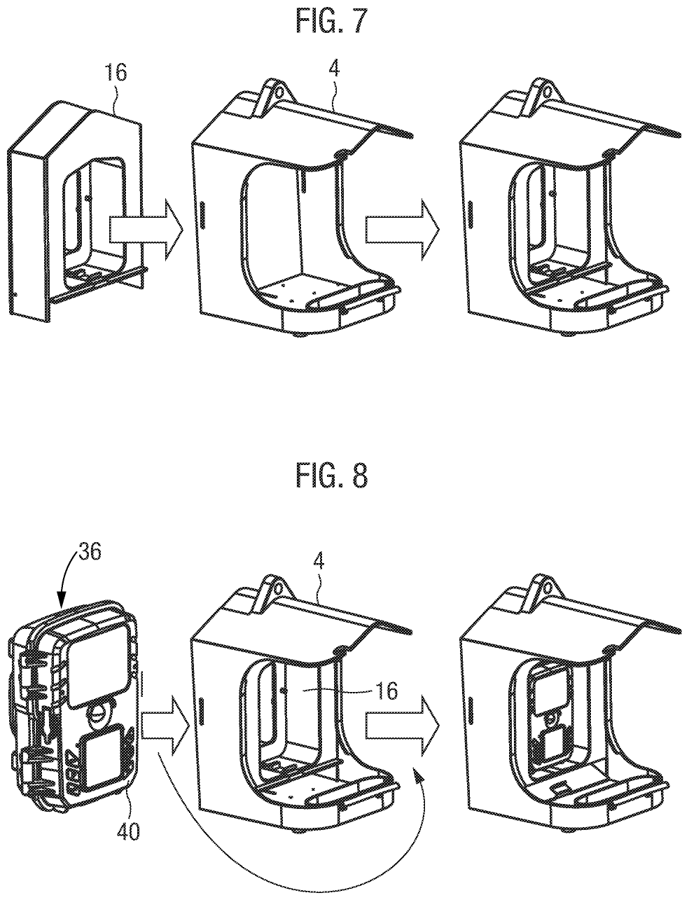

The birdhouse 2 shown fully assembled in FIG. 1 has an outer housing 4 with a base or bottom 6, two side walls 8, and a roof 10. The front and rear walls of the outer housing 4 are missing. At the front, only a flat enclosure 12 projects upward from the bottom 6. A trough-shaped drinking container 14 can be fixed there. The fixing is preferably designed to be detachable by means of clamping elements. This means that the drinking container 14 can be removed and replaced if necessary. The trough provided for holding the drinking water is arranged inside the enclosure 12 in the final assembled state; connected to the trough by webs or bars is a rod (branch-imitation) arranged outside the enclosure 12, aligned horizontally and parallel to the edge of the enclosure 12, as an approach and perching aid for the approaching birds. A birdseed container 16, also called bird feeder, is insertable into the outer enclosure or housing 4 from the rear side, up to a stop position which is formed here in the example by inwardly facing projections 18 on the front edge of the side walls 8 which act as a stop. The process of insertion during assembly is shown schematically in FIG. 7.

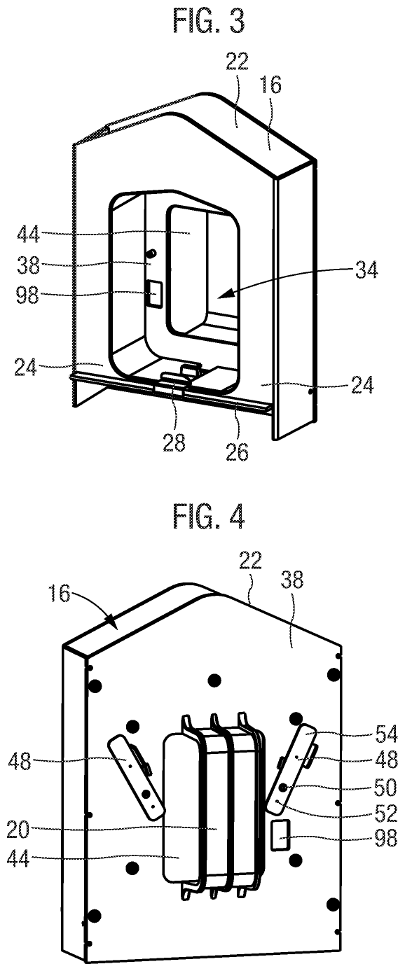

The birdseed container 16 is shown in front view in FIG. 3. The birdseed container 16 is in principle a box enclosed by a housing, the outer contour of which is matched to the contour of the rear insertion opening in the outer housing 4. A rearwardly projecting handle 20 attached to the birdseed container 16 simplifies handling during assembly and disassembly (see FIGS. 2 and 4). At the top of the birdseed container 16 is an inherently unsealed filling or feed opening 22 for birdfeed. In the final inserted state, the filling or feed opening 22 is closed by the roof 10 of the outer housing 4. On the underside of the birdseed container 16, there is at least one removal or discharge opening 24 which is arranged in an elevated position with respect to the bottom 6 and through which, during operation, a metered removal of the filled birdfeed takes place. The respective discharge opening 24 can be closed by a pivotable closure flap 26 attached to the underside of the birdseed container 16. In the upwardly pivoted closure state, the closure flap 26 is locked to the housing of the birdseed container 16 by means of a clamping element 28 acting as a closure. In the downwardly pivoted opening state, the closure flap 26 forms a slide-off slope for the birdseed emerging from the birdseed container 16 through the discharge opening 24, which birdseed collects in a feeding space 30 or feeding area on the bottom plate of the outer housing 4. Said feeding space 30 is delimited by the enclosure 12, the side walls 8, the rear wall of the birdseed container 16 and, if applicable, the inserted drinking container 14 (see FIG. 1).

The birdseed slides down automatically due to gravity when the removal or discharge opening 24 is opened. More precisely, the birdseed slides according to the set inclined plane or slope after discharge as a result of gravity to the level at which the quantity of birdseed inside the birdseed container 16 and the pushed-out birdseed are in equilibrium. The equilibrium is set in such a way that the feeding place 30, which is limited in its height by the enclosure 12, does not overflow.

A notch or cutout formed in the roof 10 of the bird house 2 forms a suspension hook 32 for a titmouse dumpling (fat ball) or the like as an additional food supply. The incision is located at the front edge of the roof 10, outside the fully covered feeding area or space 30.

The forward projection of the roof 10 beyond the bird feeding space 30 is of such a size that normally (except in extreme weather conditions) the feeding space 30 is protected from rain and is thus kept dry. Also, at the rear of the birdhouse 2, the roof 10 has an overhang, preferably of a few millimeters to centimeters, with respect to the rear of the birdseed container 16, so that rainwater running off the roof 10 cannot run into the birdseed container 16 through the feed opening 22. As a result, the birdseed in the birdseed container 16 is securely kept dry.

A recess 34 for a camera unit 36 is provided in a central area of the birdseed container 16, which is inserted from the front into a corresponding insertion opening for mounting. The insertion is limited by rear stop surfaces in the rear wall 38 of the birdseed container 16. The interior space remaining to receive the birdseed surrounds the recess 34 for the camera unit 36 in a substantially toroidal manner. The process of inserting the camera unit 36 during assembly is shown schematically in FIG. 8.

In the example, the bird feeder is divided by the recess 34 into two separate chambers (a right-hand chamber and a left-hand chamber), each of which has its own discharge opening 24 at the lower end. The two chambers can be filled with different types of birdseed.

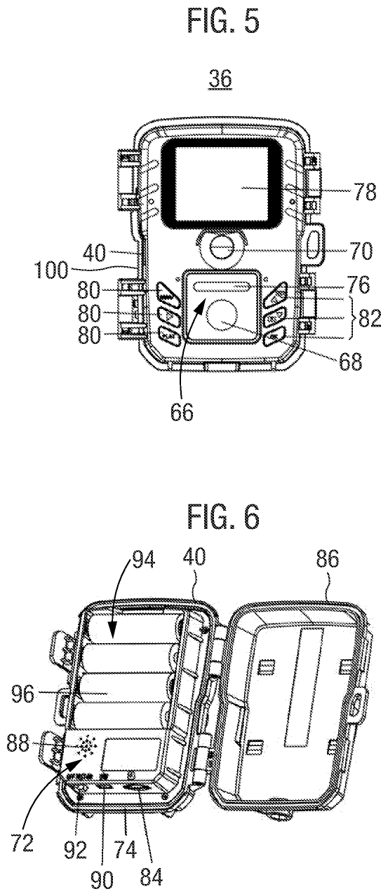

The camera unit 36 shown in a front view in FIG. 5 comprises a camera housing 40 which is substantially cuboidal in shape in this example, the outer contour of which is matched to the contour of the recess 34 in the birdseed container 16. On the rear side of the camera housing 40 are protrusions or projections 42 which, in the inserted state, engage through a recess 44 in the rear wall 38 of the birdseed container 16 and serve, on the one hand, for centering and, on the other hand, for fixing the camera unit 36 in the desired position (see FIGS. 1 and 4). For the purpose of fixation, in this example two of the projections are formed as arcuate receptacles or retaining arches 46 for associated detents. The respective detent comprises a detent or clamping lever 48 rotatably mounted externally on the rear wall 38 of the birdseed container 16, which lever is slidably rotatable about an axis of rotation 50 on the rear wall 38 and can thereby be brought into clamping engagement with the associated retaining arc 46 of the camera unit 36 at its inner end 52. This is indicated in FIG. 2, wherein the right clamping lever 48 is just about to engage the associated retaining arc 46, while the left clamping lever 48 is already fully engaged.

The respective clamping lever 48 not only fixes the camera unit 36 in the birdseed container 16, but at the same time fixes the birdseed container 16 in the outer housing 4, in that the outer end 54 of the clamping lever 48 can be brought into engagement with an associated slot-like clamping or retaining recess 56 (see FIG. 1) in the side wall 8 of the outer housing 4 when pivoted into the fixing position. During assembly, the camera unit 36 is first inserted into the birdseed container 16 and the respective clamping lever 48 is pivoted until it engages the associated retaining arc 46 of the camera unit 36, thereby fixing it in place. With this intermediate position shown in FIG. 2 for the right-hand clamping lever 48, the birdseed container 16 is inserted into the outer housing 4. The clamping lever 48 is then pivoted even further until the birdfeed container 16 is also fixed in the outer housing 4, as is the case, for example, for the clamping lever 48 on the left in FIG. 2. Preferably, the clamping levers 48 are mounted in such a way that they fall automatically into the locked position as a result of gravity when the birdseed container 16 is aligned as intended for normal operation, which facilitates single-handed assembly.

The described embodiment allows the birdseed container 16 together with the inserted camera unit 36 to be removed from the outer housing 4 and filled with birdseed when the bottom closure flap 26 is closed. If the camera unit 36 is not to be removed in the process, the respective clamping lever 48 remains in the intermediate position described above, otherwise it is opened completely. After the camera unit 36 and the birdseed container 16 have been reinserted and locked, the locking or closure flap 26 on the birdseed container 16 is opened, such that bird feeding and observation can begin. If only the camera unit 36 is to be removed, the birdseed container 16 can also remain in the outer housing 4.

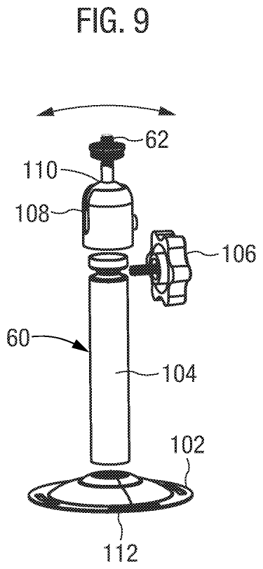

The birdhouse 2 can simply be placed on a flat surface. Alternatively, suspension is possible by means of a suspension eye 58 formed on the roof, into which a suspension strap or fastening belt or the like is hooked. As a further possibility, an installation with the aid of an associated floor stand 60 or a wall installation with the aid of a wall holder, which is shown schematically in FIG. 9 in an exploded view during assembly from individual parts, can be considered. For this purpose, the floor stand 60 or the wall bracket has a screw thread 62 formed at the end on a rod, which interacts with an associated threaded receptacle 64 (see FIG. 2) on the underside of the birdhouse 2.

Particularly advantageous is the holder shown in FIG. 9, which can be used both as a floor stand and as a wall mount. For this purpose, the holder has a disk or plate 102 which serves as a support or holding element and into which a support or holding rod 104 can be screwed centrally. A ball head sleeve 108 can be clamped to the upper end of the support or holding rod 104 by means of a clamping screw 106. A pivotably mounted ball head 110 is seated in the ball head sleeve 108, to which ball head 110 a connecting piece is integrally formed or fixedly connected, which carries the screw thread 62 for mounting the birdhouse 2. The ball head 110 is also locked in position when the clamping screw 106 is tightened. Thus, an adjustable ball head joint is realized by means of which the axis of the screw thread 62 can be bent or pivoted by up to 90° or more with respect to the axis of the support or holding rod 104, if required. As a result, the mount can also be used as a wall mount with the plate 102 resting against a wall, the support or holding rod 104 extending horizontally or at an angle from the wall, and the screw thread 62 pointing upward. This is illustrated in FIG. 10. The term ‘wall’ is to be understood in a broad sense and includes any horizontal, vertical, or inclined support surface for the plate 102. The plate 102 may be secured to the wall by means of wall plugs and associated cap screws which are passed through dedicated openings, in particular drilled holes or slots 112, around the periphery of the plate 102. Alternatively, fastening to a tree trunk without screws is also possible by passing a fastening strap through two opposing strap holes or slots 112 and looping it around the tree trunk. Fixation of the fastening strap can be effected in the tensioned state by means of suitable clamps or the like.

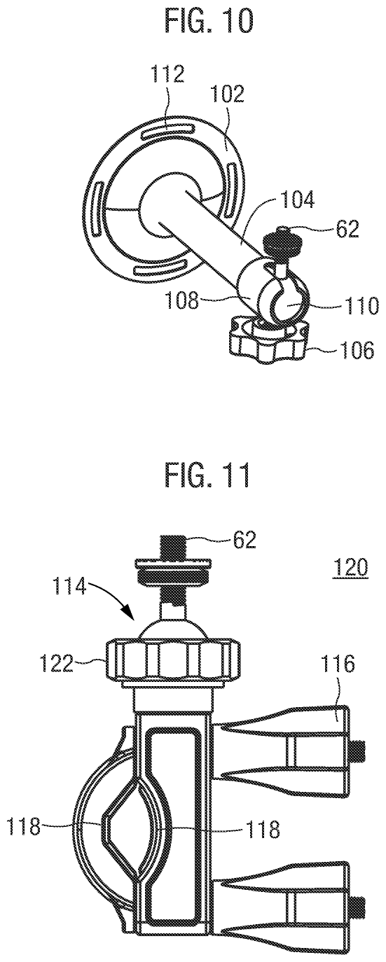

A railing attachment can also be provided in a similar manner. For this purpose, a separate clamping element with a ball joint 114 may be provided, which is shown in FIG. 11. The clamping jaws 118 of the railing bracket 120, which can be released and fixed by means of clamping screws or nuts 116, are shaped in such a way that it can be attached to any railing post which is, e.g., approximately round in cross-section and has a common diameter, for example between 17 and 32 mm. The ball joint 114, which can be locked by means of a clamping nut 122, permits horizontal alignment of the birdhouse 2 to be mounted on the screw thread 62.

The outer housing 4, the birdseed container 16 and the camera housing 40 are each preferably made of a plastic, for example as deep-drawn or injection-molded parts. The birdseed container 16 preferably consists at least partially of a transparent material or has a corresponding viewing window to allow a view into the interior and thus easy detection of the filling level of birdseed.

The birdhouse 2 is prepared for automated recording of its animal visitors by photo or video recording. For this purpose, a digital camera 66 designed for outdoor use is inserted into the camera housing 40. The camera lens 68, formed with a short objective focus, is guided through an opening in the camera housing 40 as shown in FIG. 5, facing forward toward the feeding place 30. With the aid of a motion sensor 70, in particular of the pyroelectric sensor (PIR sensor) type, which is also arranged at the front of the camera housing 40 and is directed towards the feeding place 30, the approach/presence of a bird at the feeding place 30 or even somewhat further away is detected and a photo or a photo sequence or a video is triggered by means of the digital camera 66. For this purpose, according to FIG. 6, a suitable control or control unit 72 is integrated into the camera unit 36, which couples the motion sensor 70 in a corresponding manner to the trigger of the digital camera 66. Further, a microphone 74 may be provided to record audio and add an audio track (bird chirping) to a video sequence. An array of light emitting diodes, particularly infrared light emitting diodes (IR LEDs) 76, may be provided on the front of the camera housing 40 to illuminate the scene during photographic or cinematic capture. The control unit 72 integrated into the camera unit 36 synchronizes the illumination with the recording. A user can configure the camera and sensor system, such as setting the number of photos per trigger, the length of the video sequence, the image resolution, the sensor sensitivity, and more, via a display 78 arranged on the outside of the front of the camera housing 40 and via key-shaped controls or operating elements 80 as part of an operating unit 82, which may additionally or alternatively be virtually integrated into a touch display.

During night, the infrared LEDs 76 are preferably switched on automatically to provide the necessary light for capturing images/videos. The camera control system detects night either by means of a separate brightness sensor located on the outside of the camera housing 40 or by evaluating the signals from the image sensor integrated in the digital camera 66. In night mode, the image sensor is sensitive to IR light emitted by the infrared LEDs 76. Alternatively, the camera lens 68 has an infrared filter that can preferably be activated automatically.

The images taken by the digital camera 66 are stored on a removable and replaceable storage medium, in particular a Secure Digital Memory Card (SD card). The corresponding insertion slot 84 is preferably located within the camera housing 40 and is only accessible when the rear cover flap 86 is open as shown in FIG. 6. Furthermore, a speaker 88 for acoustic feedback during operation, a USB port 90, preferably of the micro-USB or USB-C type, and/or an on/off switch 92 may be arranged there. As a result, these sensitive components are particularly well protected from the weather. The apertures or recesses in the front of the camera housing 40 for the components led out, in particular motion sensor 70, camera lens 68, and display 78, are sealed to be at least splash-proof. The same applies to any operating elements 80 that may be present. The cover flap 86 is also sealed with respect to the housing base body. Penetration of moisture into the sensitive digital camera 66, the motion sensor 70, the insertion slot 84, or the control electronics is consistently prevented. The interior of the camera body 40, which is accessible when the cover shell or flap 86 is open, also includes a battery compartment 94 for the batteries 96 or rechargeable batteries required for operation. Alternatively, the electronic components can also be supplied with operating voltage via a (low voltage) DC connection 100 by means of a connectable power cable. The DC connection 100 is led out of the camera housing 40 and, when not in use, can be closed by a sealing plug, preferably made of rubber-elastic material. An associated power cable feedthrough 98 through the rear wall 38 of the birdseed container 16 can be seen in FIGS. 3 and 4.

To read the photographic data saved or stored on the storage medium, in particular memory card, into an external computer, the camera unit 36 is removed from the birdhouse 2 as described above and the cover flap 86 is opened. Then either the memory card is removed and inserted into an external card reader adapter, or a data connection is established using a USB cable which is inserted into the USB port 90.

Preferably, the digital camera 66 also has a loop mode in which a video or series of photos (preferably with a selectable pause interval between two photos) is continuously recorded. When the storage medium is full, the beginning of the series of photos or video is continuously overwritten. The triggering of the digital camera 66 controlled by the motion sensor 70 is then suitably disabled. In such a loop mode, the birdhouse 2 can also be used for unobtrusive surveillance of a property or estate.

Finally, some preferred technical specifications of the birdhouse 2 and its electronic components are listed summarily:
Battery operated for indoor and outdoor use
Optimized for recording and observing birds (short lens focus 6-15 cm; wide viewing angle of 100°.
Lens with Auto IR Filter
FullHD video resolution 1080 p
Slow motion videos with up to 25 FPS playback
2″ (5 cm) TFT LCD display (528×220)
1/3.2″ CMOS sensor with 8 MP
Functions: Video, Photo, Video & Photo or Slow Motion.
PIR sensor (˜20 cm) with 60° viewing angle
IR range (˜50 cm) with 940 nm LEDs for night photography
Automatic switching: Color images by day/black and white images by night
Triggering time 0.3 s
Integrated microphone & speaker
Removable birdfeed container for approx. 150 g bird food
Tit dumpling (fat ball) hook
Removable water trough
Micro SD card up to 512 GB
Camera protection class IP56 (dustproof & strong splashproof)

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

### LIST OF REFERENCE NUMERALS

2 birdhouse

4 outer housing

6 floor/bottom

8 side wall

10 roof

12 enclosure

14 drinking container

16 birdseed container

18 projection/protrusion

20 handle

22 feed opening

24 discharge opening

26 closure flap

28 clamping element

30 feeding place

32 suspension hook

34 recess

36 camera unit

38 rear wall

40 camera housing

42 projection/protrusion

44 recess

46 retaining arch

48 clamping lever

50 rotational axis

52 inner end

54 outer end

56 recess

58 suspension eye

60 floor stand

62 screw thread

64 thread mount

66 digital camera

68 camera lens

70 motion sensor

72 control unit

74 microphone

76 infrared light emitting diodes

78 display

80 operating element

82 operating unit

84 insertion slot

86 cover flap

88 speaker

90 USB port

92 on/off switch

94 battery compartment

96 battery

98 power cable feedthrough

100 DC connection

102 plate

104 support or holding rod

106 clamping screw

108 ball head sleeve

110 ball head

112 slot

114 ball joint

116 clamping screw or nut

118 clamping jaw

120 rail bracket

122 clamping nut

What is claimed is:

1. A birdhouse (2), comprising:
an outer housing (4);
a birdseed container (16) insertable into the outer housing (4) for mounting therein; and
a camera unit (36) insertable into the birdseed container (16) and comprising
a digital camera (66),
a motion sensor (70), and
a control unit (72) which triggers the digital camera (66) when the motion sensor (70) detects an approach or a presence of a bird.

2. The birdhouse (2) according to claim 1,
wherein the birdseed container (16) is insertable into the outer housing (4) from a rear side.

3. The birdhouse (2) according to claim 1,
wherein the camera unit (36) is insertable into the birdseed container (16) from a front side.

4. The birdhouse (2) according to claim 1,
wherein in a final assembly state the camera unit (36) is arranged in a central recess (34) of the birdseed container (16).

5. The birdhouse (2) according to claim 1,
wherein the birdseed container (16) has a discharge opening (24) for birdseed on an underside which can be closed by a closure flap (26).

6. The birdhouse (2) according to claim 5,
wherein the closure flap (26) in an open state forms a slope for birdseed to slide down to a feeding place (30) formed in a bottom area of the outer housing (4).

7. The birdhouse (2) according to claim 1,
further comprising a locking or clamping lever (48) pivotally mounted on a rear wall (38) of the birdseed container (16), which serves both for locking the birdseed container (16) in the outer housing (4) and for locking the camera unit (36) in the birdseed container (16).

8. The birdhouse (2) according to claim 7,
wherein the locking or clamping lever (48) is designed in such a way that the birdseed container (16) together with the camera unit (36) can be removed as a unit from the outer housing (4).

9. The birdhouse (2) according to claim 1,
wherein the camera unit (36) comprises a slot (84) for a memory card for storing photos or videos taken with the digital camera (66).

10. The birdhouse (2) according to claim 1,
wherein the camera unit (36) comprises at least one light emitting diode, provided for illuminating a field of view of the digital camera (66), which light emitting diode is activated by the control unit (72) synchronously with the triggering of the digital camera (66).

11. The birdhouse (2) according to claim 10,
wherein the light emitting diode is an infrared light emitting diode (76) and
wherein the digital camera (66) comprises an image sensor sensitive to infrared light and/or a camera lens (68) with an infrared filter.

12. The birdhouse (2) according to claim 1,
wherein the birdseed container (16) is at least partially made of optically transparent material.

13. The birdhouse (2) according to claim 1,
wherein the motion sensor (70) is a pyroelectric sensor.

14. The birdhouse (2) according to claim 1,
wherein the control unit (72) has various operating modes which can be selected via an operating unit (82).

15. The birdhouse (2) according to claim 1,
wherein the camera unit (36) comprises a splash-proof camera housing (40) with a sealed cover flap (86).
